(19) United States
(12) Patent Application Publication
(10) Pub. No.: US 2011/0271498 A1
(43) Pub. Date: Nov. 10, 2011

(54) Framing or Deck Board Clamp

(76) Inventor: Daniel Charles PRICE, Cambridge, MD (US)

(21) Appl. No.: 13/095,662

(22) Filed: Apr. 27, 2011

Related U.S. Application Data
(60) Provisional application No. 61/331,906, filed on May 6, 2010.

(51) Int. Cl. F16B 2/04

(52) U.S. Cl. 24/457

(57) ABSTRACT

The present invention is a framing or deck board clamp mainly used to hold an unfastened board and a fastened board together while the user fasten the unfastened board. The present invention allows the user to overcome the time consuming nature of aligning wooden boards, which usually are not cut with perfect straight edges. The apparatus coverts the rotational motion conveniently provided by a power drill into the linear motion required to clamp the unfastened board to the fastened board. The present invention comprises simple, light weight components, which make the apparatus relatively easy to use and relatively maintenance-free.

The current application claims a priority to the U.S. Provisional Patent application Ser. No. 61/331,906 filed on May 6, 2011.

### FIELD OF THE INVENTION

The present invention relates generally to a device that will facilitate the installation of boards. More specifically, the boards used for patio decking, sub flooring, and/or a structure's framing members by pushing or pulling those elements that are bent, crooked, or otherwise out of place.

### BACKGROUND OF THE INVENTION

Currently, the installation of boards for patios, decks, and things of that nature can be time consuming due to the misalignment of the boards. Wooden boards are not delivered with straight edges. Whether it be from dull saws or minor decomposition, wooden boards are not perfect. The objective of the present invention, a power drill attachment, allow users to align and clamp a fastened board and an unfastened board together so the user does not have to manually hold the boards together when securing the unfastened board. The present invention will drastically reduce the time to install boards since the user does not have to hold the boards together because the present invention will clamp the boards together.

### BRIEF DESCRIPTION OF THE DRAWINGS

FIG. 1 is a side view of the present invention separated into two parts.

FIG. 2 is the bottom view of the present invention.

FIG. 3 is a side view of the present invention in an extended mode.

FIG. 4 is a side view of the present invention in a retracted mode.

FIG. 5 is a side view showing the present invention aligning a wooden board.

FIG. 6 is a side view showing the present invention adjusting a warped framing member.

### DETAIL DESCRIPTIONS OF THE INVENTION

All illustrations of the drawings are for the purpose of describing selected versions of the present invention and are not intended to limit the scope of the present invention.

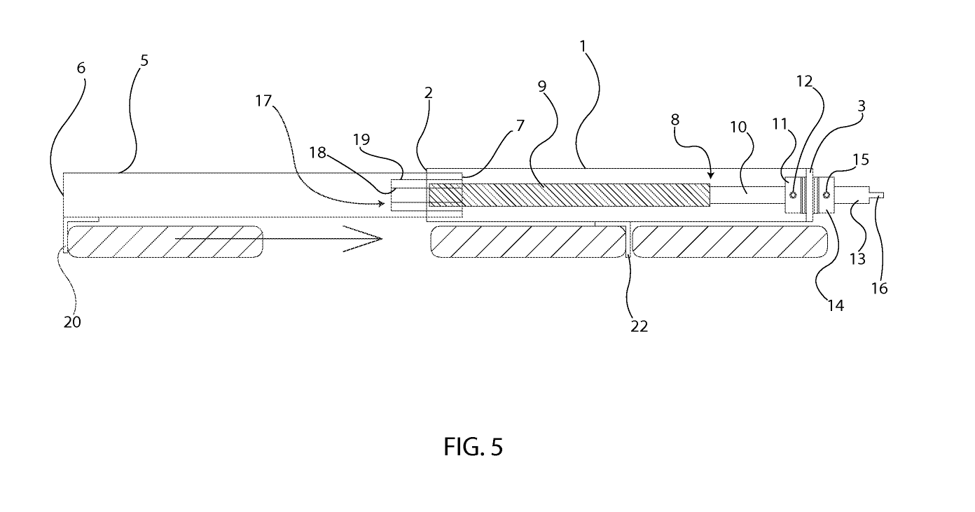

The present invention is a framing or deck board clamp, which allows the user to clamp an unfastened board to a fastened board by utilizing the rotational motion of a power drill as shown in FIG. 5. In the preferred embodiment of the present invention, the apparatus should be roughly 14 inches in length. The apparatus is compact, light weight, and easy for one worker to use unassisted. The framing or deck board clamp comprises of an outer tube 1, an inner tube 5, a male threaded shaft 8, a chuck dock 16, a female threaded fitting 17, a front tab 20, a front fastener 21, a back tab 22, and a back fastener 23. The outer tube 1 and the inner tube 5 provide the apparatus with a frame and a base for all other components of the apparatus to be connected together. The male threaded shaft 8, the chuck dock 16, and the female threaded fitting 17 provide the apparatus with the means to change the rotational motion of the power drill into the linear motion required to clamp the unfastened board to the fastened board. The front tab 20, the front fastener 21, the back tab 22, and the back fastener 23 allow the apparatus to engage the unfastened board and the fastened board.

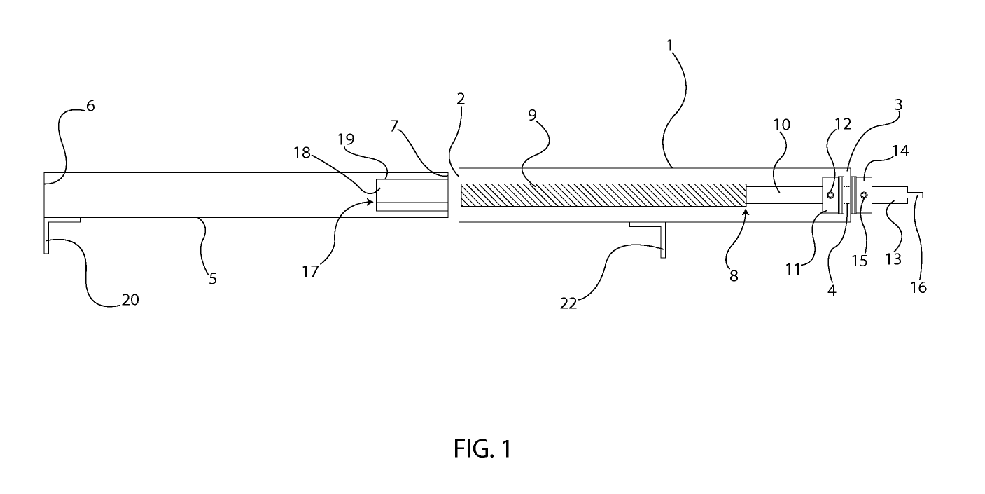

As can be seen in FIG. 1, the outer tube 1 and the inner tube 5 gives the present invention its overall shape. The outer tube 1 is a rigid and comprises an open end 2, a closed end 3, and a shaft hole 4. The open end 2 is an opening located on and shaped by the front geometric base of the outer tube 1. The closed end 3 is a panel located on and shaped by the back geometric base of the outer tube 1. The shaft hole 4 is positioned on the center of the closed end 3. The inner tube 5 is also rigid and comprises a first end 6 and a second end 7. The first end 6 and the second end 7 are both openings located on and shaped the geometric bases of the inner tube 5. The first end 6 is located at the front of the inner tube 5, and the second end 7 is located at the back of the inner tube 5. In the preferred embodiment, the cross section of outer tube 1 and the cross section of the inner tube 5 are squares but these cross sections can be any shape. In order for the apparatus to perform its clamping function, the second end 7 of the inner tube 5 must easily fit and slide into the outer tube 1 through the open end 2. The cross section of the inner tube 5 must have an appropriate geometric perimeter to fit and slide into the outer tube 1. If the geometric perimeter of the inner tube 5 is too large, then there may be too much friction between the lateral surface of the inner tube 5 and the lateral surface of the outer tube 1 to easily slide the inner tube 5 within the outer tube 1. If the geometric perimeter of the inner tube 5 is too small, then the inner tube 5 will not stay properly situated within the outer tube 1. The closed end 3 prevents the inner tube 5 from slide too far backwards and falling out of the outer tube 1.

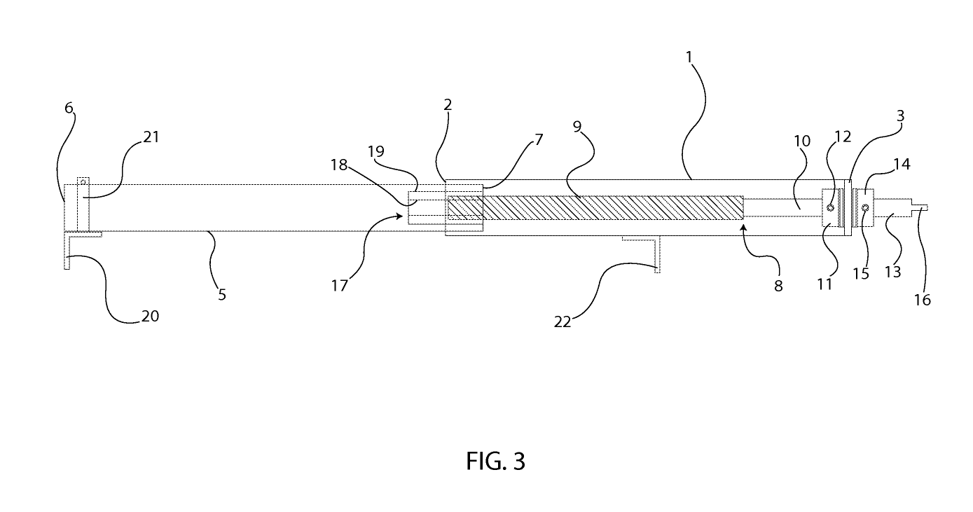

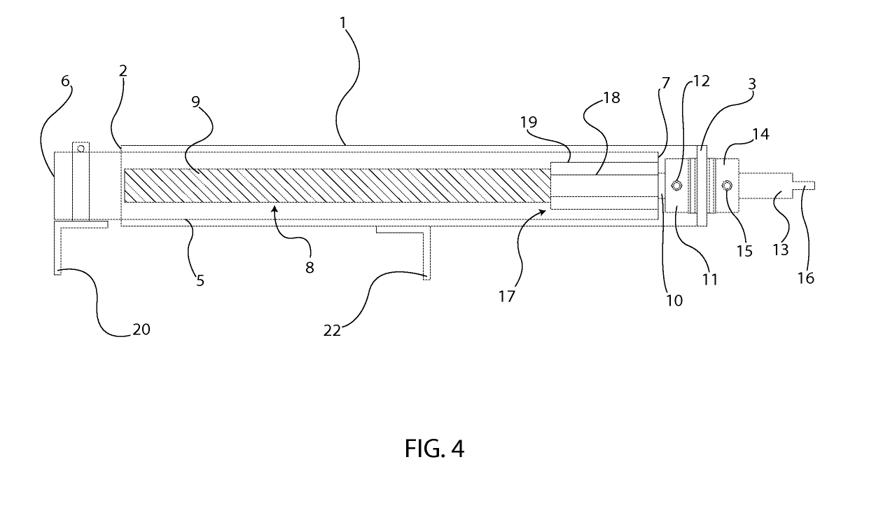

As shown in FIG. 3 and FIG. 4, the mechanism used by the present invention to implement its clamping function consists of the following components: the male threaded shaft 8, the chuck dock 16, and the female threaded fitting 17. The male threaded shaft 8 runs the full length of the outer tube 1 and traverses through the shaft hole 4, which guides the rotation of the male threaded shaft 8. The male threaded shaft 8 lies along the center axis of the outer tube 1, which is also the axis of rotation for the male threaded shaft 8. The male threaded shaft 8 comprises a threaded portion 9, an inside portion 10, an inside stop 11, inside fastener 12, an outside portion 13, an outside stop 14, and an outside fastener 15. The threaded portion 9 is the front part of the male threaded shaft 8 and is located within the outer tube 1. The threaded portion 9 has helix shaped teeth that spiral around the center axis of the outer tube 1. The inside portion 10 is the middle part of the male threaded shaft 8 and is located inside of the outer tube 1. The inside portion 10 has a typical cylindrical shape found on a shaft or rod. The outside portion 13 is the back part of the male threaded shaft 8 and is located outside of the outer tube 1. The outside portion 13 has the same cylindrical shape as the inside portion 10. The inside stop 11 is an annular object encircling the inside portion 10 and is adjacent to the closed end 3. The inside stop 11 is attached to the inside portion 10 by the inside fastener 12 in order to prevent the male threaded shaft 8 from moving too far backward. The diameter of the inside stop 11 must be small enough to rotate freely without make contact with the lateral surface of the outer tube 1 and large enough to buttress the male threaded shaft 8 against the closed end 3 so that the male threaded shaft 8 is supported along the center axis of the outer tube 1. Similarly, the outside stop 14 is an annular object encircling the outside portion 13 and is adjacent to the closed end 3. The outside stop 14 is attached to the outside portion 13 by the outside fastener 15 in order to prevent the male threaded shaft 8 from moving too far forward. The diameter of the outside stop 14 must be smaller than the diameter of the lateral surface of the outer tube 1 so that the outside stop 14 does not become an obstruction when clamping the unfastened board to the fastened board. The diameter of the outside stop 14 must also be large enough to buttress the male threaded shaft 8 against the closed end 3 so the male threaded shaft 8 is supported along the center axis of the outer tube 1. The inside stop 11 and the outside stop 14 must have the appropriate space between them. If the space between the inside stop 11 and the outside stop 14 is too small, then the male threaded shaft 8 will not be able to rotate freely because there will be too much friction between the inside stop 11, the closed end 3, and the outside stop 14. If the space between the inside stop 11 and the outside stop 14 is too large, then the male threaded shaft 8 might wobble off the center axis of the outer tube 1.

The male threaded shaft 8 residing on the center axis of the outer tube 1 is important because the male threaded shaft 8 must be properly positioned to engage the female threaded fitting 17, which is located inside of the inner tube 5 and adjacent to the second end 7. The female threaded fitting 17 is an tubular insert having an outer surface 19 and a threaded inner surface 18. The outer surface 19 is connected to the lateral surface of the inner tube 5. The threaded inner surface 18 has the corresponding helix shaped teeth to engage the threaded portion 9 of the male threaded shaft 8. Once the male threaded shaft 8 has engaged the female threaded fitting 17, the inner tube 5 can be slid into or slid out of the outer tube 1 by rotating the male threaded shaft 8 in one direction or another. The male threaded shaft 8 and the female threaded fitting 17 change rotational motion into the linear motion experienced by the inner tube 5 moving in and out of the outer tube 1. The rotational motion is provided by the power drill, which is relatively common household tool. The power drill provides rotational motion that is precise, powerful, and without manual effort. The chuck dock 16 allows the chuck of the power drill to engage and rotate the male threaded shaft 8. The chuck dock 16 is connected to back of the outside portion 13. The chuck dock 16 must be properly sized and configured to allow the chuck of any power drill to engage the male threaded shaft 8.

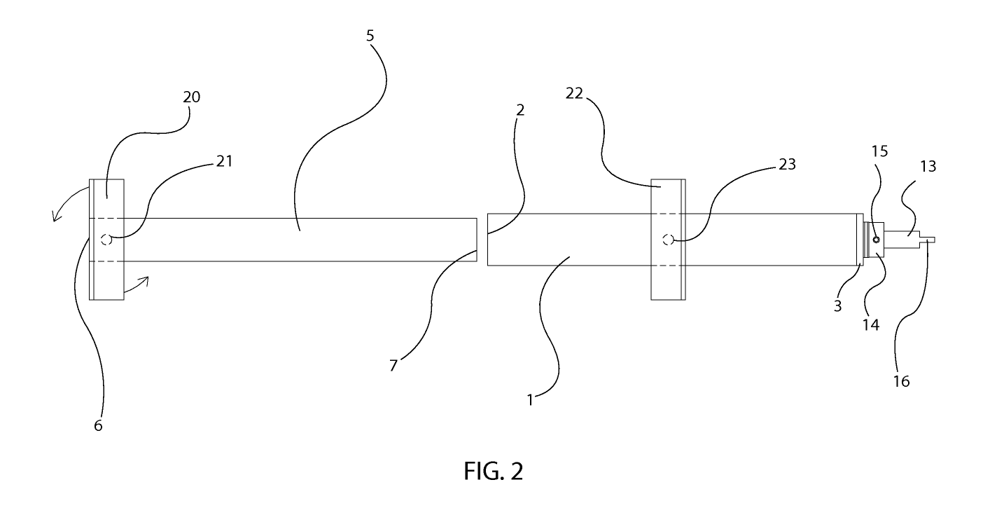

The present invention engages the deck boards with the front tab 20 and the back tab 22 shown in FIG. 2. The front tab 20 is a rectangular protrusion adjacent to the first end 6 and located on the bottom of the inner tube 5. The length of the front tab 20 is perpendicular to the center axis of the outer tube 1 and the inner tube 5. The front tab 20 allows the apparatus to apply the necessary force to move the unfastened board towards the fastened board and, eventually, clamp them together. In the preferred embodiment, the front tab 20 is a steel angle that engages the outside corner of the unfasten board. The front tab 20 connects to the inner tube 5 with a front fastener 21. The front fastener 21 must be completely flushed so that there are no obstructions when the apparatus engages the unfastened board. The front fastener 21 allows the user to easily detach the front tab 20 from the inner tube 5 and allows for future attachments that can substitute for the front tab 20. Likewise, the back tab 22 is a rectangular protrusion located on the bottom and near the middle of the outer tube 1. The length of the back tab 22 is perpendicular to the center axis of the outer tube 1 or the inner tube 5. The back tab 22 situates the apparatus in the proper position to perform the clamping function. The back tab 22 is placed in the gap between the fastened board and an adjacent fastened board so that the framing joists are not needed as anchor points for the apparatus. In the preferred embodiment, the back tab 22 would also be a steel angle. The back tab 22 attaches to the outer tube 1 with back fastener 23. Similarly, the back fastener 23 must be flushed so that there are no obstructions when the apparatus is situated among the fastened boards.

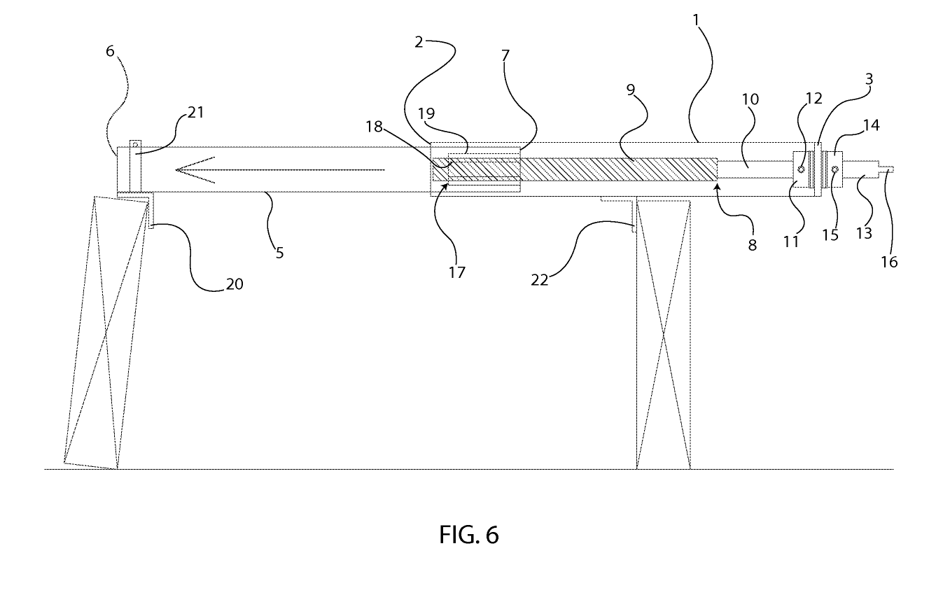

The present invention is used to clamp an unfastened board to a fastened board, but the present invention can be used in other applications. Basically, the apparatus provides the user with a pushing or pulling force on the right corners of any two pieces of wood, which is conveniently plied with a power drill. For example, the present invention can be used to correctly space two warped framing members as shown in FIG. 6.

Although the invention has been explained in relation to its preferred embodiment, it is to be understood that many other possible modifications and variations can be made without departing from the spirit and scope of the invention as hereinafter claimed.

What is claimed is:

1. A framing or deck board clamp comprises,
an outer tube;
an inner tube;
a male threaded shaft;
a chuck dock;
a female threaded fitting;
a front tab;
a front fastener;
a back tab;
a back fastener;
said outer tube comprises an open end, a closed end, and a shaft hole; and
said inner tube comprises a first end and a second end.

2. Said framing or deck board clamp as claimed in claim 1 comprises,
said outer tube being traversed by said inner tube through said open end; and
said inner tube being concentric with said outer tube.

3. Said framing or deck board clamp as claimed in claim 1 comprises,
said shaft hole being positioned centrally on said closed end;
said male threaded shaft traversing through said shaft hole;
said male threaded shaft being connected pivotally to said closed end
said male threaded shaft being concentric with said outer tube;
said female threaded fitting being located within said inner tube;
said female threaded fitting being concentric with said inner tube;
said female threaded fitting being connected to said inner tube adjacent to said second end;
said female threaded fitting being engaged by said male threaded shaft; and
said chuck dock being connected to said male threaded fastener.

4. Said framing or deck board clamp as claimed in claim 1 comprises,
said front tab being connected below to inner tube by said front fastener;
said front tab being located adjacent to said first end;
said back tab being connected below to outer tube by said back fastener; and
said back tab being located equally in between said open end and said closed end.

5. Said framing or deck board clamp as claimed in claim 1 comprises,
said male threaded shaft comprises a threaded portion, an inside portion, an inside stop, an inside fastener, and outside portion, an outside stop, and an outside fastener; and
said female threaded fitting comprises an outer surface and a threaded inner surface.

6. Said framing or deck board clamp as claimed in claim 5 comprises,
said threaded portion, said inside portion, and said outside portion being connected collinearly;
said threaded portion being located inside of said outer tube;
said inside portion being located inside of said outer tube;
said outside portion being located outside of said outer tube and said inner tube;
said inside stop being attached to said inside portion by said inside fastener;
said inside stop being attached adjacent to said closed end;
said outside stop being attached to said outside portion by said outside fastener; and
said outside stop being attached adjacent to said closed end.

7. Said framing or deck board clamp as claimed in claim 5 comprises,
said outer surface being connected to said inner tube; and
said threaded inner surface being engaged by said threaded portion.

8. Said framing or deck board clamp as claimed in claim 5 comprises,
said chuck dock being connected to said outer portion.

9. A framing or deck board clamp comprises,
an outer tube;
an inner tube;
a male threaded shaft;
a chuck dock;
a female threaded fitting;
a front tab;
a front fastener;
a back tab;
a back fastener;
said outer tube comprises an open end, a closed end, and a shaft hole;
said inner tube comprises a first end and a second end;
said male threaded shaft comprises a threaded portion, an inside portion, an inside stop, an inside fastener, and outside portion, an outside stop, and an outside fastener; and
said female threaded fitting comprises an outer surface and a threaded inner surface.

10. Said framing or deck board clamp as claimed in claim 9 comprises,
said outer tube being traversed by said inner tube through said open end; and
said inner tube being concentric with said outer tube.

11. Said framing or deck board clamp as claimed in claim 9 comprises,
said shaft hole being positioned centrally on said closed end;
said male threaded shaft traversing through said shaft hole;
said male threaded shaft being connected pivotally to said closed end
said male threaded shaft being concentric with said outer tube;
said female threaded fitting being located within said inner tube;
said female threaded fitting being concentric with said inner tube;
said female threaded fitting being connected to said inner tube adjacent to said second end;
said female threaded fitting being engaged by said male threaded shaft; and
said chuck dock being connected to said male threaded fastener.

12. Said framing or deck board clamp as claimed in claim 9 comprises,
said front tab being connected below to inner tube by said front fastener;
said front tab being located adjacent to said first end;
said back tab being connected below to outer tube by said back fastener; and
said back tab being located equally in between said open end and said closed end.

13. Said framing or deck board clamp as claimed in claim 9 comprises,
said threaded portion, said inside portion, and said outside portion being connected collinearly;
said threaded portion being located inside of said outer tube;
said inside portion being located inside of said outer tube;
said outside portion being located outside of said outer tube and said inner tube;
said inside stop being attached to said inside portion by said inside fastener;
said inside stop being attached adjacent to said closed end;
said outside stop being attached to said outside portion by said outside fastener; and
said outside stop being attached adjacent to said closed end.

14. Said framing or deck board clamp as claimed in claim 9 comprises,
said outer surface being connected to said inner tube; and
said threaded inner surface being engaged by said threaded portion.

15. Said framing or deck board clamp as claimed in claim 9 comprises,
said chuck dock being connected to said outer portion.

16. A framing or deck board clamp comprises,
an outer tube;
an inner tube;
a male threaded shaft;
a chuck dock;
a female threaded fitting;
a front tab;
a front fastener;
a back tab;
a back fastener;
said outer tube comprises an open end, a closed end, and a shaft hole;
said inner tube comprises a first end and a second end;
said male threaded shaft comprises a threaded portion, an inside portion, an inside stop, an inside fastener, and outside portion, an outside stop, and an outside fastener;
said female threaded fitting comprises an outer surface and a threaded inner surface;
said outer tube being traversed by said inner tube through said open end;
said inner tube being concentric with said outer tube;
said shaft hole being positioned centrally on said closed end;
said male threaded shaft traversing through said shaft hole;
said male threaded shaft being connected pivotally to said closed end
said male threaded shaft being concentric with said outer tube;
said female threaded fitting being located within said inner tube;
said female threaded fitting being concentric with said inner tube;
said female threaded fitting being connected to said inner tube adjacent to said second end;
said female threaded fitting being engaged by said male threaded shaft; and
said chuck dock being connected to said male threaded fastener.

17. Said framing or deck board clamp as claimed in claim 16 comprises,
said front tab being connected below to inner tube by said front fastener;
said front tab being located adjacent to said first end;
said back tab being connected below to outer tube by said back fastener; and
said back tab being located equally in between said open end and said closed end.

18. Said framing or deck board clamp as claimed in claim 16 comprises,
said threaded portion, said inside portion, and said outside portion being connected collinearly;
said threaded portion being located inside of said outer tube;
said inside portion being located inside of said outer tube;
said outside portion being located outside of said outer tube and said inner tube;
said inside stop being attached to said inside portion by said inside fastener;
said inside stop being attached adjacent to said closed end;
said outside stop being attached to said outside portion by said outside fastener; and
said outside stop being attached adjacent to said closed end.

19. Said framing or deck board clamp as claimed in claim 16 comprises,
said outer surface being connected to said inner tube; and
said threaded inner surface being engaged by said threaded portion.

20. Said framing or deck board clamp as claimed in claim 16 comprises,
said chuck dock being connected to said outer portion.
